(19) United States
(12) Patent Application Publication
(10) Pub. No.: US 2006/0131300 A1
(43) Pub. Date: Jun. 22, 2006

(54) Method for performing a magnetic pulse welding operation

(76) Inventor: Boris A. Yablochnikov, Toledo, OH (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/286,708

(22) Filed: Nov. 23, 2005

Related U.S. Application Data
(60) Provisional application No. 60/630,929, filed on Nov. 24, 2004.

(51) Int. Cl. B23K 13/01

(52) U.S. Cl. 219/617

(57) ABSTRACT

A method of performing magnetic pulse welding operation to secure first and second metallic components together involves initially increasing the temperature of a first portion of the first metallic component to soften same without substantially increasing the temperature of and softening a second portion of the first metallic component adjacent to the first portion. Then, the first portion of the first metallic component is disposed in an axially overlapping manner relative to a portion of the second metallic component with a space therebetween. An inductor is provided relative to the axially overlapping portions of the first and second metallic components. The inductor is energized to deform the first portion of the first metallic component into engagement with the portion of the second metallic component so as to secure the first and second metallic components together.

### CROSS-REFERENCE TO RELATED APPLICATIONS

This application claims the benefit of U.S. Provisional Application No. 60/630,929, filed Nov. 24, 2004, the disclosure of which is incorporated herein by reference.

### BACKGROUND OF THE INVENTION

This invention relates in general to magnetic pulse welding techniques for securing two metallic components together. In particular, this invention relates to an improved method for performing such a magnetic pulse welding operation that minimizes the amount of undesirable distortions that can result in one or both of the metallic components.

In most land vehicles in use today, a drive train system is provided for transmitting rotational power from an output shaft of an engine/transmission assembly to an input shaft of an axle assembly so as to rotatably drive one or more wheels of the vehicle. To accomplish this, a typical vehicular drive train assembly includes a cylindrical driveshaft tube having first and second end fittings that are secured to the opposite ends thereof. The first end fitting forms a portion of a first universal joint, which provides a rotatable driving connection from the output shaft of the engine/transmission assembly to a first end of the driveshaft tube, while accommodating a limited amount of angular misalignment between the rotational axes of these two shafts. Similarly, the second end fitting forms a portion of a second universal joint, which provides a rotatable driving connection from a second end of the driveshaft tube to the input shaft of the axle assembly, while accommodating a limited amount of angular misalignment between the rotational axes of these two shafts.

In vehicular driveshaft assemblies of this general type, it is usually necessary to permanently secure the first and second end fittings to the ends of the driveshaft tube. Traditionally, conventional welding techniques have been used to permanently join the first and second end fittings to the ends of the driveshaft tube. As is well known, conventional welding techniques involve the application of heat to localized areas of two metallic members, which results in a coalescence of the materials of the two metallic members. Such conventional welding techniques may or may not be performed with the application of pressure and may or may not include the use of a filler material. Although conventional welding techniques have functioned satisfactorily in the past, there are some drawbacks to the use thereof. First, as noted above, conventional welding techniques involve the application of heat to localized areas of the two metallic members. This application of heat can cause undesirable distortions and weaknesses to be introduced into the metallic components. Second, while conventional welding techniques are well suited for joining components that are formed from similar metallic materials, it has been found to be somewhat more difficult to adapt them for use in joining components formed from dissimilar metallic materials. Third, conventional welding techniques are not easily adapted for joining components that have different gauge thicknesses. Inasmuch as the production of vehicular driveshaft assemblies is usually a high volume process, it would be desirable to provide an improved method for permanently joining these metallic components together in a manner that avoids the drawbacks of conventional welding techniques.

Magnetic pulse welding is an alternative process that has been proposed to secure the first and second end fittings to the opposed ends of the driveshaft tube. To accomplish this, a driveshaft tube having an end portion and an end fitting having a neck portion are initially provided. The end fitting is typically embodied as a tube yoke or a tube shaft. The yoke has a pair of opposed arms that extend therefrom in a first axial direction. A pair of aligned openings is formed through the yoke arms and is adapted to receive conventional bearing cups of the universal joint cross therein. A generally hollow neck portion extends axially in a second axial direction from the body portion. To perform the magnetic pulse welding operation, an end portion of the driveshaft tube is installed co-axially about the neck portion of the end fitting. When the driveshaft tube and the yoke are assembled in this manner, an annular gap or space is defined between the inner surface of the end of the driveshaft tube and outer surface of the neck portion of the yoke. An electrical inductor is then disposed about the assembly of the driveshaft tube and the yoke. The inductor is energized to generate an immense and momentary electromagnetic field about the end portion of the driveshaft tube. This electromagnetic field exerts a very large force on the outer surface of the tube end, causing it to collapse inwardly at a high velocity onto the neck portion of the yoke. The resulting impact of the inner surface of the tube end with the outer surface of the neck portion of the yoke causes a weld or molecular bond to occur therebetween.

It has been found that the high velocity impact of the tube end onto the neck portion of the yoke during the magnetic pulse welding operation can, in some instances, cause the yoke arms to be permanently deflected relative to one another. For example, if the end of the tube is collapsed upon the neck portion of the yoke, the inward deformation of the neck portion can cause the yoke arms on the other end of the yoke to spread outwardly apart from one another. Also, the shock wave propagated through the yoke as a result of this impact can slightly enlarge the dimensions of the openings formed through the yoke arms. These events are particularly likely to occur when the yoke is formed from a relatively lightweight material, such as an alloy of aluminum. Such deflections of the yoke arms are undesirable because they can result in the misalignment of the respective openings formed there through. When the openings formed through the yoke arms are not precisely aligned, it may be relatively difficult to properly install the remaining portions of the universal joint thereon and to balance the universal joint for rotation.

The tube shaft usually has a tube seat, a bearing or boot portion, a necked down portion and a splined end portion. Because of the high stress, the best practical material to satisfy demands for producing the tube shaft is middle carbonic steel. If the driveshaft tube is also formed from a steel material, then a conventional arc welding process is usually used for securing the tube shaft thereto. However, in order to reduce vehicular weight, obtain smooth operation, and improve fuel economy, it is sometimes preferable to make some of the components of the driveshaft assembly from lighter weight materials, such as aluminum. In many cases, the yoke and driveshaft tube can both be formed from relatively strong aluminum alloys, such as 6061-T6 and can be successfully secured together by using known arc-welding methods. However, it has been found to be somewhat difficult to use this method to provide a high quality welding joining of an aluminum driveshaft tube and a steel tube shaft because brittle intermetallic structures can form, the presence of which can decrease the strength of the joint therebetween. Other techniques have been tested with varying degrees of success to solve the problem of achieving a high quality joint between an aluminum driveshaft tube and a steel end fitting. Today, the magnetic pulse welding and friction welding technologies (both of which are cold welding processes) appear to show the best results.

Friction welding technology is older and better developed, especially in the area of the availability of good production machines. However, it appears as if the friction welding process has some practical limitations if it is used to weld steel-aluminum driveshaft assemblies with tube diameter of more than 90 mm and a wall thickness less than 3 mm. In contrast, magnetic pulse welding is a younger technology and less is somewhat developed, especially as regards production machines, but it appears to provide better results if the diameter of the driveshaft tube is 50 mm to 150 mm and the wall thickness is 1.5 mm to 3 mm. Thus, magnetic pulse welding is a promising technology for solving the problem of high quality welding the steel-aluminum driveshaft assemblies.

The shock waves and deformation of the tube seat in the process of the magnetic pulse welding operation do not produce any significant distortion in the splined end of the tube shaft. However, due to practical limits of manufacturing and the impossibility of providing the ideal concentricity of the to-be-welded parts themselves and relative to the inductor axis, the driveshaft in the welding area could be bent beyond the acceptable limits. It has been found that the more powerful the magnetic pulse used in the process of the magnetic pulse welding, the more distortions can occur in the driveshaft after welding. As a consequence of this bending and the above mentioned yoke distortions, high run-out of the driveshaft could result, which is a significant parameter relative to the way in which unbalance is affected by various operating speeds. Over a wide speed range, especially at high speeds, this parameter is an important single factor in dynamic balancing. An unbalanced centrifugal force proportional to the square of the rotational speed causes deflection, stresses, and vibration, which may result in component failure and objectionable noise and ride feel for the occupants of a vehicle.

Thus, it would be desirable to provide an improved method of performing a magnetic pulse welding operation that minimizes the amount of undesirable run-out the driveshaft that can result in yoke distortions or bending in the tube shaft welding area when a driveshaft tube is secured thereto by the magnetic pulse welding operation.

### SUMMARY OF THE INVENTION

This invention relates to an improved method of performing magnetic pulse welding operation to secure first and second metallic components together. Initially, the temperature of a first portion of the first metallic component is increased to soften same without substantially increasing the temperature of and softening a second portion of the first metallic component adjacent to the first portion. Then, the first portion of the first metallic component is disposed in an axially overlapping manner relative to a portion of the second metallic component with a space therebetween. An inductor is provided relative to the axially overlapping portions of the first and second metallic components. The inductor is energized to deform the first portion of the first metallic component into engagement with the portion of the second metallic component so as to secure the first and second metallic components together.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is an exploded elevational view, partially in cross section, of a driveshaft tube and a pair of end fittings shown prior to being assembled and secured together in accordance with the method of this invention.

FIG. 2 is a sectional elevational view of a portion of the driveshaft tube and one of the end fittings illustrated in FIG. 1 shown assembled and disposed within an inductor for performing a magnetic pulse welding operation.

FIGS. 3a, 3b, 3c, and 3d show different layouts for performing the magnetic pulse welding operation.

FIGS. 4a, 4b, and 4c show the basic manner of positioning the to-be-welded parts of the driveshaft assembly in predetermined positions relative to each other and to the inductors in accordance with this invention.

FIG. 5 is a sectional view showing the driveshaft tube end located inside of a preheating inductor and tube yoke located within a supporting tooling incorporated with the pulse inductor in accordance with this invention.

FIG. 6 is an enlarged sectional view of the tube yoke supporting tooling positioned relative to the tube yoke.

FIG. 7 is an end elevational view of the tube yoke supporting tooling shown in FIG. 6.

FIG. 8 is a sectional elevational view showing the tube shaft and the supporting tooling incorporated within the pulse inductor.

### DETAILED DESCRIPTION OF THE PREFERRED EMBODIMENT

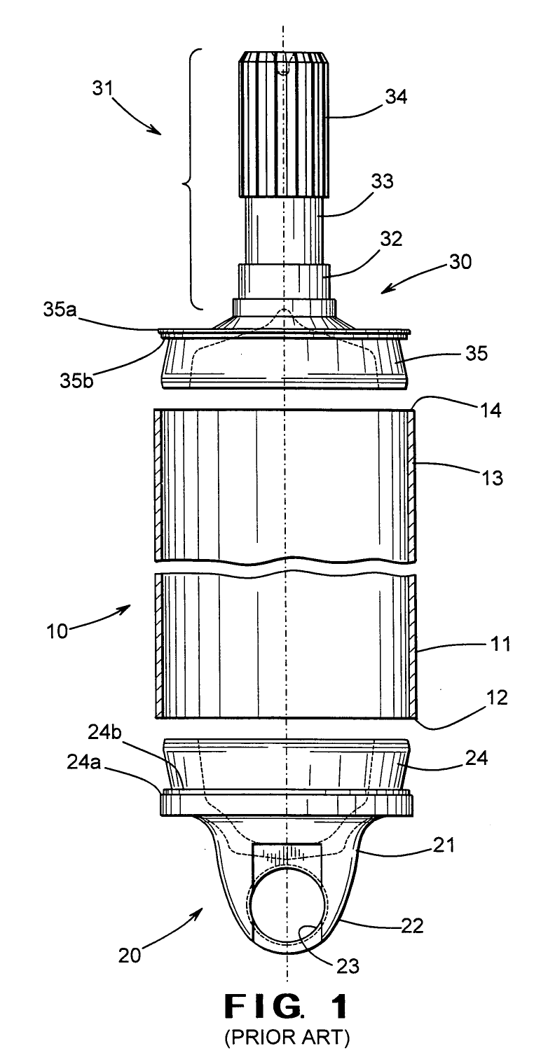

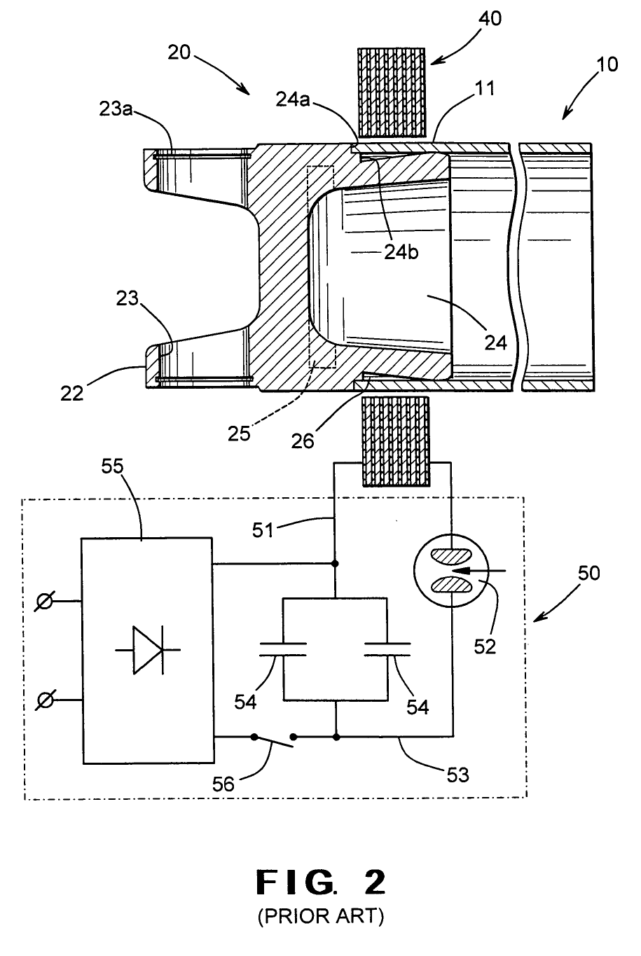

Referring now to the drawings, there is illustrated in FIGS. 1 and 2 a driveshaft tube, indicated generally at 10, a first end fitting, such as a tube yoke indicated generally at 20, and a second end fitting, such as a tube shaft indicated generally at 30. Although this invention will be described and illustrated in the context of securing the first and second end fittings 20 and 30 to the driveshaft tube 10 to form at least a portion of a driveshaft assembly, it will be appreciated that the method of this invention can be used to secure any two metallic components together for any desired purpose or application.

The illustrated driveshaft tube 10 is generally hollow and cylindrical in shape and can be formed from any desired metallic material, such as 6061-T6 aluminum alloy, for example. Preferably, the driveshaft tube 10 has an outer surface that defines a substantially constant outer diameter and an inner surface that defines a substantially constant inner diameter. Thus, the illustrated driveshaft tube 10 has substantially cylindrical and uniform wall thickness, although such is not required. The driveshaft tube 10 has a first end portion 11 that terminates at an end surface 12 and a second end portion 13 that terminates at an end surface 14.

The illustrated first end fitting 20 is a tube yoke that is formed from metallic material that can be either the same as or different from the metallic material used to form the driveshaft tube 10, such as steel or an alloy of aluminum, for example. The illustrated first end fitting 20 includes a body portion 21 having a pair of opposed yoke arms 22 that extend therefrom in a first axial direction. A pair of aligned openings 23 is formed through the yoke arms 22 and are adapted to receive conventional bearing cups (not shown) of a universal joint cross therein. If desired, an annular groove 23a (see FIG. 2) can be formed within each of the openings 23 to facilitate retention of the bearing cups therein in a known manner by means of respective snap rings (not shown). A generally hollow neck portion 24 extends in a second axial direction from the body portion 21 opposite to the first axial direction defined by the yoke arms 22. The neck portion 24 is provided with an annular shoulder 24a and an annular step 24b, a pilot surface of which is preferably tapered at a small angle, such as from about five degrees to about nine degrees.

The structure of the neck portion 24 is described in detail in U.S. Pat. No. 6,892,929, which issued on May 17, 2005 and is owned by the assignee of this invention. The disclosure of that application is incorporated herein by reference. If desired, an annular groove 25, such as shown by the dotted line in FIG. 2, or similar recessed area can be formed on the interior of the first end fitting 20. The purpose for this internal groove 25 is also explained in detail in U.S. Pat. No. 6,892,929.

The illustrated second end fitting 30 is a tube shaft that is usually formed from carbonic steel. The illustrated second end fitting 30 includes a body portion, indicated generally at 31, having three areas, namely, a bearing or boot seat portion 32, a reduced diameter portion 33, and a splined end portion 34. A generally hollow neck portion 35 has the same structure as is described in detail in above-mentioned U.S. Pat. No. 6,892,929. In particular, the neck portion 35 is provided with an annular shoulder 35a and annular step 34b.

FIG. 2 also illustrates an inductor 40 disposed about the assembly of the driveshaft tube 10 and the first end fitting 20 prior to the performance of a magnetic pulse welding operation for securing the two components together in accordance with the method of this invention. When the driveshaft tube 10 and the first end fitting 20 are assembled in this manner, an annular gap or space 26 is defined between the inner surface of the end portion 11 of the driveshaft tube 10 and outer surface of the neck portion 24 of the tube yoke 20. The inductor 40 can be formed having any desired structure, such as that shown and described in U.S. Pat. No. 4,129,846 to Yablochnikov. The disclosure of that patent is incorporated herein by reference. The inductor 40 is connected to a schematically illustrated pulse power source, indicated generally at 50. As shown in FIG. 2, a first lead of the inductor 40 is connected to a first electrical conductor 51, while a second lead of the inductor 40 is connected through a discharge switch 52 to a second electrical conductor 53. A plurality of high voltage capacitors 54 or similar energy storage devices are connected between the first and second electrical conductors 51 and 53. The first electrical conductor 51 is also connected to a source of electric energy 55, while the second electrical conductor 53 is connected through a charging switch 56 to the source of electric energy 55. The structure and operation of the control circuit is described in detail in the U.S. Pat. No. 5,981,921 to Yablochnikov, and the disclosure of that patent is also incorporated herein by reference.

The operation of the inductor 40 to perform the magnetic pulse welding operation is well known in the art, and reference is again made to the above-referenced U.S. Pat. No. 5,981,921 for detailed explanation. Briefly, however, the inductor 40 is operated by initially opening the discharge switch 52 and closing the charging switch 56. This allows electrical energy to be transferred from the source of electric energy 55 to each of the capacitors 54. When the capacitors 54 have been charged to a predetermined voltage, the charging switch 56 is opened. Thereafter, when it is desired to operate the inductor 40, the discharge switch 52 is closed. As a result, a high energy pulse of electric current flows from the capacitors 54 through the inductor 40, thereby generating an immense and momentary electromagnetic field about the end portion 11 of the driveshaft tube 10. This electromagnetic field exerts a very large force on the outer surface of the end portion 11 of the driveshaft tube 10, causing it to collapse inwardly at a high velocity onto the neck portion 24 of the yoke 20 (or, as discussed above, the neck portion 35 of the tube shaft 30).

The resulting impact of the inner surface of the end portion 11 of the driveshaft tube 10 with the outer surface of the neck portion 24 of the yoke 20 causes a weld or molecular bond to occur therebetween as a result of electron sharing between the atoms of the two metals across their common interface. The size and location of the weld region will vary with a variety of factors, such as the size of the annular gap 26, the size, shape and nature of the metallic materials used to form the driveshaft tube 10 and the yoke 20, the size and shape of the inductor 40, the angle and velocity of the impact between the end portion 11 of the driveshaft tube 10 and the neck portion 24 of the yoke 20, and other factors.

As discussed above, it has been found that the high velocity impact of the end portion 11 of the driveshaft tube 10 onto the neck portion 24 of the first end fitting 20 during magnetic pulse welding operation can, at least is some instances, cause undesirable distortions in the shape of one or both of the components. It has been found that the magnitude of such distortions increases with increases in the velocity of the impact between the two components. However, as the strength of the material used to form the driveshaft tube 10 increases, higher impact velocities have been traditionally necessary to provide the atomic bond of the two metals across their common interface. To provide such higher impact velocities, it has been traditionally necessary to increase the magnitude of the magnetic field energy pulse created by the pulse power source 50, which can accelerate wear on the elements of the pulse power circuit 50. Thus, it would be desirable to improve the magnetic pulse welding process so as to provide a good quality welding join using a lesser magnitude of the magnetic field energy pulse created by the pulse power source 50.

One known method of reducing the magnitude of the magnetic field energy pulse created by the pulse power source 50 is based on reducing the material yield strength of the material of the component to be deformed. To accomplish this, it is known to subject the portion of the driveshaft tube 10 to be deformed to a retrogressive heat treatment. A typical retrogressive heat treatment cycle includes the steps of initially induction heating a specific area of the driveshaft tube 10 to about 1000° F. for about ten to fifteen seconds, then quenching the heated driveshaft tube 10 in water at room temperature. After the retrogressive heat treatment has been performed, the yield strength of 6061-T6 aluminum alloy typically drops from 40 ksi to about 10 ksi, which permits significant reduction in the magnitude of the magnetic field energy pulse that is necessary to perform the magnetic pulse welding process.

However, one disadvantage of the retrogressive heat treatment technique in the context of performing a magnetic pulse welding operation is that during the cooling step, the energy that was used to heat the driveshaft tube 10 (which can be about twenty times greater than the energy used during the magnetic pulse welding operation) is not only wasted, but becomes unavailable as a theoretically beneficial asset of the welding process. Indeed, to weld metal pieces, the surface atoms are activated by accepting any kind of energy. Heating is a convenient and effective way to provide the atoms with the necessary energy for activation. So, theoretically, just preheating the tube ends should be better for performing the magnetic pulse welding operation on the driveshaft than merely using the retrogressive heat treatment technique.

Many important innovations related to induction preheating on magnetic pulse technology were suggested in U.S. Pat. No. 3,126,937, the disclosure of which is incorporated herein by reference. Although the idea of preheating in a magnetic pulse welding process is not of itself new, this invention advances the technology a step further. In most of the previous arts for preheating and creating the magnetic pulse, the same inductor is used for both purposes, and the to-be-welded pieces are assembled inside the inductor before the preheating cycle starts. A basic disadvantage of this layout is the necessity of switching the inductor from being the heating source to being the pulse source in the process of welding. It can be done relatively easily if the diameter of to-be-welded pieces is relatively small (about 25 mm, for example) because the current in the pulse inductor is relatively low. However, it becomes more difficult if the diameter of to-be-welded pieces is relatively large (about 100 mm to about 150 mm, for example, which is typical for a vehicular driveshaft application) because the current amplitude can be more than one million amperes. Another problem is providing cooling of the inductor, which is used both for heating and for creating the powerful magnetic pulse. The bulk of the heat is accepted by the inductor in the process of preheating and is typically so high that it can be removed only with the help of a water cooling system. Unfortunately, it has been found to be unfeasible to use water cooling in the inductor design of U.S. Pat. No. 4,129,846, which is best for magnetic pulse welding tubular parts of relatively large diameter.

The use of a separate inductor for preheating and creating the magnetic pulse is also known. In particular, U.S. Pat. No. 3,621,175 describes an apparatus including an induction heating coil and magnetic welding coil that are located at spaced locations along the path of moving two to-be-welded elements simultaneously with the help of a conveyor. The to-be-welded elements could be tubular and concentric, and the inside element has an outside surface next to the inside surface of the outside element. According to this patent, the invention provides for continuous welding, particularly of pipes and preliminary slip fit inside liners. In operation, the pipe and the liner are both heated to the same temperature and welded in the process of feeding by rollers through heating coil and welding coil at a speed of about fifteen meters per minute and activating the welding coil ten times per second. Parameters defined by the welding coil and its control circuit are chosen so that the current pulse has a characteristic frequency that creates an induced current in the pipe and liner whose skin depth is greater than the thickness of one of the two overlapping conductors (and preferably greater than the total thickness of the overlapped conductors). As a result, the magnetic forces generated in the pipe and liner cause them to be attracted toward each other.

In this invention, there is a space separating the to-be-welded surfaces of the end portion 11 of the driveshaft tube 10 and the neck portion 24 of the first end fitting 20, both in the process of preheating and in the process of assembling the to-be-welded parts inside the pulse inductor. In the process of preheating, the to-be-welded parts could be apart from each other or could overlap in a manner relative to their to-be-welded surfaces and be in contact, but just by the internal circular ridge of the to-be-welded tube end outside to-be-welded surfaces of the parts. As an option, an additional heating inductor can be used for preheating the fitting neck. Parameters defined by the pulse inductor and the discharge circuit are chosen so that skin depth in the driveshaft tube is less than the tube wall thickness. As a result, the magnetic forces generated between the tube and pulse inductor cause the tube end to be repelled from the inductor, which provides the high speed collapsing of the to-be-welded tube and fitting portions.

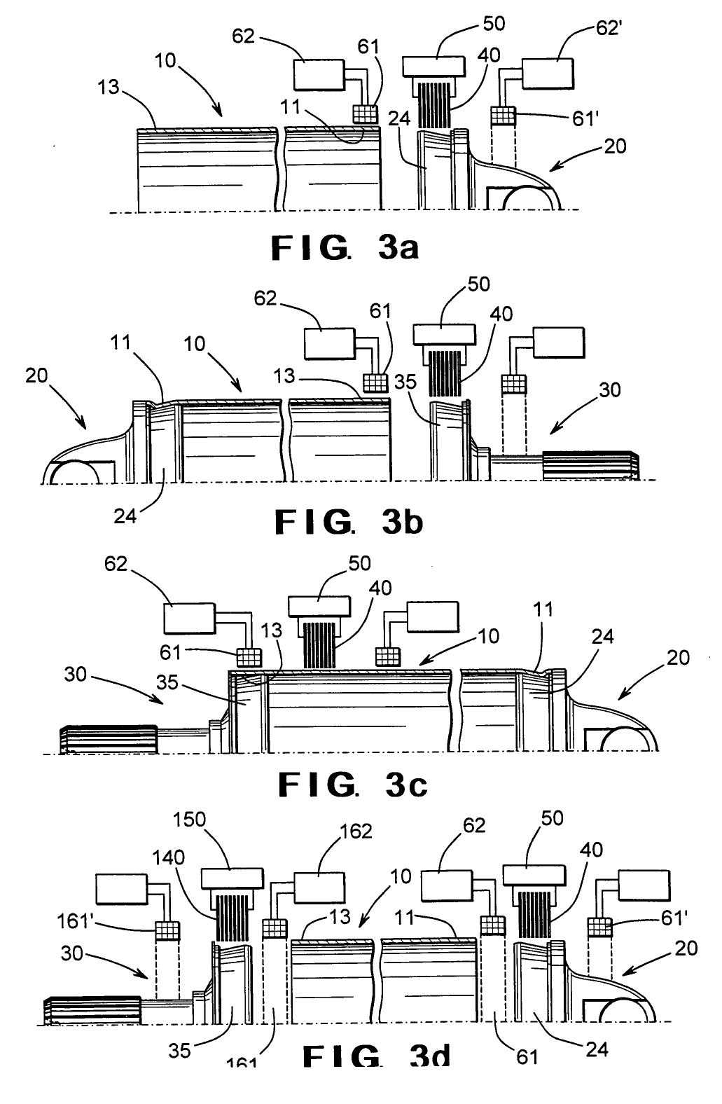

For purpose of explanation, the method of this invention is described hereafter in two steps. The first step describes the general layouts to realize the method; the second step is a more specific description connected with the apparatus and the tooling that may be employed to practice the method. The general layouts of the first step are shown in FIGS. 3a through 3d, wherein:

FIG. 3a illustrates a process of magnetic pulse welding the first end portion 11 of the driveshaft tube 10 to the first end fitting 20 with the help of one set of the inductors (e.g. one main heating inductor and one pulse inductor), where the fitting tooling is located on just one side of the pulse inductor (an additional inductor for preheating the neck portion 24 of the first end fitting 20 can be optionally used);

FIG. 3b illustrates a process of magnetic pulse welding the second end portion 13 of the driveshaft tube 10 to the second end fitting 30 after initially welding the first end portion 11 of the driveshaft tube 10 as shown in FIG. 3a, and further after turning the driveshaft tube 10 end over end (an additional inductor for preheating the neck portion 35 of the second end fitting 30 can be optionally used);

FIG. 3c illustrates the process of magnetic pulse welding both end portions 11 and 13 of the driveshaft tube 10 to the first and second end fittings 20 and 30, respectively, with the help of one set of inductors by locating the fitting tooling from both sides of the pulse inductor and transporting the driveshaft tube 10 through the preheating and pulse inductors from one end to the other after magnetic pulse welding the first end (an additional inductor for preheating the neck portions 24 and 35 of the first and second end fittings 20 and 30, respectively, can be optionally used); and

FIG. 3d illustrates the process of magnetic pulse welding both end portions 11 and 13 of the driveshaft tube 10 with the help of two sets of inductors by locating the fitting tooling from just one side of each pulse inductor, preliminarily locating the tube between the main preheating inductors and transporting the driveshaft tube 10 in the opposite direction for magnetic pulse welding the second end after magnetic pulse welding the first end (the two additional inductors for preheating the neck portions 24 and 35 of the first and second end fittings 20 and 30, respectively, can be optionally used).

The process shown in FIGS. 3a and 3b starts with inserting the first end portion 11 of the driveshaft tube 10 inside a preheating inductor 61 and inserting the neck portion 24 of the yoke 20 into the pulse inductor 40 described above, as shown in FIG. 3a. The preheating inductor 61 is energized by a high frequency source 62, and the capacitor battery of pulse power source 50 is charged to a predetermined voltage. After preheating the end portion 11 of the driveshaft tube 10 to a predetermined temperature, the high frequency source 62 is switched off. Then, the driveshaft tube 10 is quickly moved in an axial direction into the pulse inductor 40 and is stopped at the moment that the first end portion 11 of the driveshaft tube 10 is correctly positioned relative to the first end fitting 20, as shown in FIG. 2. The pulse inductor 40 is then energized by means of discharging the capacitors of the pulse power supply 50 as described above, which accomplishes the magnetic pulse welding cycle of the first end portion 11 of the driveshaft tube 10.

After that, the half-welded driveshaft tube 10 is removed from the inductors 40 and 61 and turned about such that the second end portion 13 of the driveshaft tube 10 is inserted inside the preheating inductor 61, as shown in FIG. 3b. Then, the welding cycle is repeated as described above with the second end fitting 30. Optionally, before inserting the neck portions 24 and 35 of the end fittings 20 and 30, respectively, inside the pulse inductor 40, either or both could be preheated with the help of an additional heating inductor, such as shown at 61′, which can be energized by an additional high frequency source, such as shown at 62′. In this instance, the end fittings 20 or 30 would be inserted into the pulse inductor 40 either immediately before or simultaneously with inserting the associated preheated end portions 11 or 13 of the driveshaft tube 10.

As can be seen from the description, this method may not be very appropriate for the high volume production, which is typical of driveshaft manufacture. It is, however, good for use in low volume production when simply handled, relatively inexpensive tooling can be incorporated with pulse inductors, as will be shown later.

The process shown in FIG. 3c is initiated by welding the first end portion 11 of the driveshaft tube 10 with the tube yoke 20 in the manner shown in FIG. 3a. In this case, however, to weld the second end portion 13 of the driveshaft tube 10, the second end fitting 30 is preliminarily inserted into the second end portion 13 of the driveshaft tube 10 and used to push the second end portion 13 of the driveshaft tube 10 into the preheating inductor 61. To do this, the second end portion 13 of the driveshaft tube 10 and second end fitting 30 come into contact with each other in a manner that will be described later. After preheating, the driveshaft tube 10 and second end fitting 30 are transported inside the pulse inductor 40, and the magnetic pulse welding operation is performed thereon. This process is more appropriate for high volume production, but its productivity is somewhat limited by the need to transport the full length of the driveshaft tube 10 between the two welding cycles and the need to prepare two sequential capacitor discharges with a single pulse power supply 50.

The process shown in FIG. 3d for welding both end portions 11 and 13 of the driveshaft tube 10 is the generally same as described above in connection with FIG. 3a. However, in this instance, two preheating inductors 61 and 161 (and their associated high frequency sources 62 and 162) and two pulse inductors 40 and 140 (and their associated pulse power sources 50 and 150) are provided. Because two sets of inductors are provided, the driveshaft tube 10 needs to move back and forth only a relatively short distance during the magnetic pulse welding operation, stopping at the necessary positions initially inside the preheating inductors 61 and 161 and subsequently inside the pulse inductors 40 and 140. After welding the two end fittings 20 and 30 to the respective end portions 11 and 13, the driveshaft tube 10 is positioned in the middle between the heating inductors 61 and 161, then is removed transversely relative to the axis defined by such inductors 61 and 161. Optionally, before inserting the neck portions 24 and 35 of the end fittings 20 and 30, respectively, inside either of the pulse inductors 40 and 140, they could be preheated with the help of an additional heating inductors 61′ and 161′, similar to those described above. In this last instance, the end fittings 20 or 30 would be inserted into the respective inductors 40 and 140 immediately before or simultaneously with inserting the associated preheated end portions 11 or 13 of the driveshaft tube 10. This process is the most appropriate for high volume production because of the short distance that the tooling and driveshaft need to be transported and because the time to prepare two sequential capacitor discharges is not a critical issue for two pulse power supplies 50.

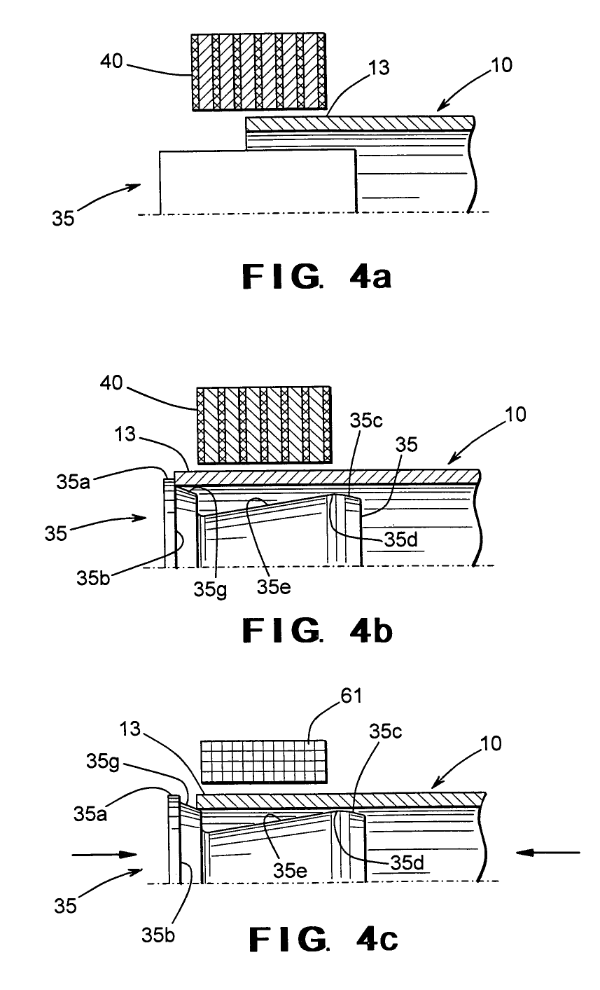

FIGS. 4a, 4b, and 4c show the basic positions of the second end portion 13 of the driveshaft tube 10 relative to the neck portion 35 of the second end fitting 30 and to the inductors 40 and 61, which can be used in all the above-described layouts. The position shown in FIG. 4a could be provided by appropriate tooling because the shape, for example, of the neck portion 35 of the second end fitting 30 does not facilitate it being in contact with the second end portion 13 of the driveshaft tube 10 before energizing the pulse inductor 40. This type of arrangement is acceptable for many magnetic pulse welding applications, but it may not be the best choice for producing automotive driveshafts. The precision demands of a driveshaft after welding are so high that it is likely that the use of the neck shapes shown in FIGS. 4b and 4c can satisfy them. This shape in general was described above and here is supplemented by more detailed description of outer surfaces of the neck portion 35, which can be important in providing quality and precise magnetic pulse welding.

As shown in both FIGS. 4b and 4c, a first tapered surface 35c can be provided on the neck portion 35 that facilitates inserting the neck portion 35 within the end portion 13 of the driveshaft tube 10. The first tapered surface 35c terminates at a maximum outer diameter transition area 35d that preferably provides preliminary radial orientation of the two components 10 and 30 when assembled. A second tapered surface 35e is provided to promote a high quality of welding during the magnetic pulse welding process. A third tapered surface 35g is provided on the annular step 35b and provides for a final radial orientation of the assembled components 10 and 30. Lastly, the annular shoulder 35a provides for precise axial positioning of such components 10 and 30.

For precision of welding, it is desirable, in case of using the layout shown in FIG. 3b, that the maximum diameter of the third tapered surface 35g be substantially equal to the inner diameter of the to-be-welded end portion 13 of the driveshaft tube 10 after preheating, as shown in FIG. 4b. For example, a driveshaft tube 10 that is formed from 6061-T6 aluminum alloy and has an initial inner diameter of 127 mm and wall thickness of 2 mm will expand about 2 mm as a result of preheating to the 700° F.-1000° F. temperature that is optimal for welding according with the present invention. So, without taking this expansion into account, run-out on the welded driveshaft could be 1 mm, which may not be acceptable.

If the layout shown in FIG. 3b is used, then it is preferred that both the maximum outer diameter transition area 35d and the minimum outer diameter of the third tapered surface 35g of the neck portion 35 of the second end fitting 30 be substantially equal to the inner diameter of the to-be-welded end portion 13 of the driveshaft tube 10 before preheating, as shown in FIG. 4c. The maximum outer diameter of the third tapered surface 35g is preferably substantially equal to the inner diameter of the to-be-welded end portion 13 of the driveshaft tube 10 after preheating, as shown in FIG. 4b. Consequently, as shown in FIG. 4c, before preheating, an internal circular ridge of the to-be-welded end portion 13 of the driveshaft tube 10 inside the inductor 61 is in contact with the beginning of the third tapered surface 35g of the neck portion 35 of the second end fitting 30. To secure this contact in process of preheating, an axial force (indicated by the two arrows in FIG. 4c) can be applied to move the driveshaft tube 10 to stop at the shoulder 35a. However, it should be noted that the various components described above may have any desired sizes.

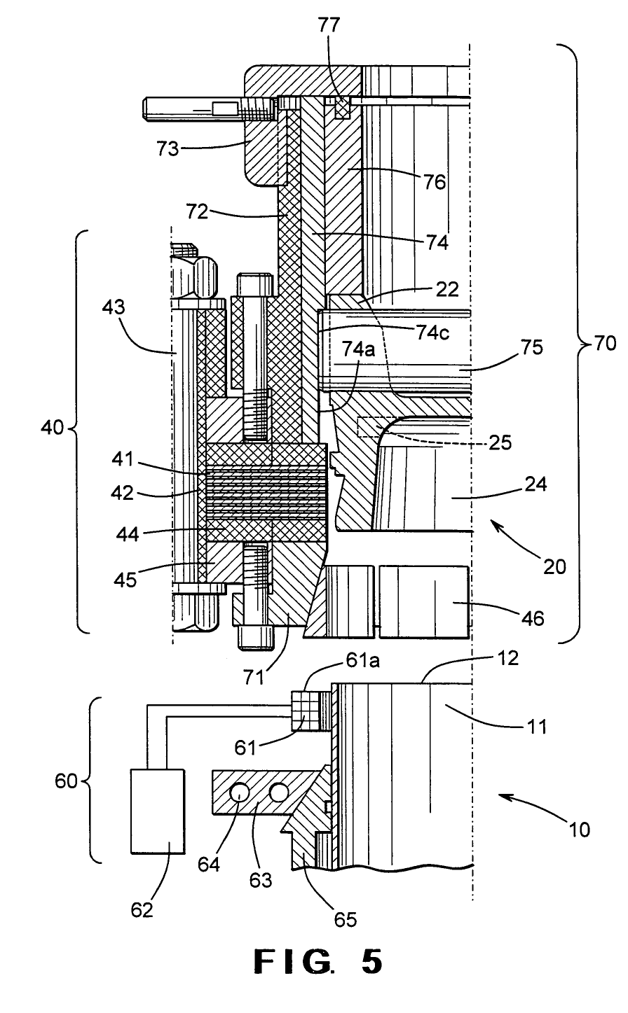

To provide all the tube and fitting displacements in high volume manufacturing of the driveshaft assembly using the described magnetic pulse welding method, it is desirable, but not required, that fully mechanized and automated tooling has to be used. Discussion of this tooling is out of the scope of this invention. For purpose of explanation, however, the method of this invention is described hereafter in connection with the apparatus and a version of tooling that may be employed to practice the method. More specifically, the apparatus shown in FIG. 5 includes a means, indicated generally at 60, for preheating the end portion 11 of the driveshaft tube 10 and a means, indicated generally at 70, for performing the magnetic pulse welding operation. As shown therein, the preheating means 60 includes the heating inductor 61 connected with the high frequency power supply 62 and a cooler 63 having one or more passageways 64 for circulation of water therethrough. Inserts 65 are operated with the help of an axially moving device (not shown). Both the cooler 63 and the inserts 65 are preferably formed from a high heat-conductive metallic material, such as brass, for example.

The magnetic pulse welding means 70 includes the pulse inductor, indicated generally at 40, a directed bushing 71, a tooling bushing 72 with a union nut 73, a yoke bushing 74, a pin 75, and a counter die 76 retained by damper 77. The inductor 40 is assembled from a series of metallic 41 and insulating 42 rings that are shaped as relatively thin plates and are compressed by a row of powerful electrically insulated bolts 43 through insulating 44 and metallic 45 rings that are shaped as thick relatively plates. The bolts 43 are passed through precisely machined openings in the rings 41, 42, 44, and 45 (only the central parts of the inductor elements are shown). The tooling bushing 72 can be formed from either a metallic or an insulator material, depending upon the manner in which the inductor 40 is grounded. The inductor 40 also includes a segmented clamp 46, the purpose of which will be explained below.

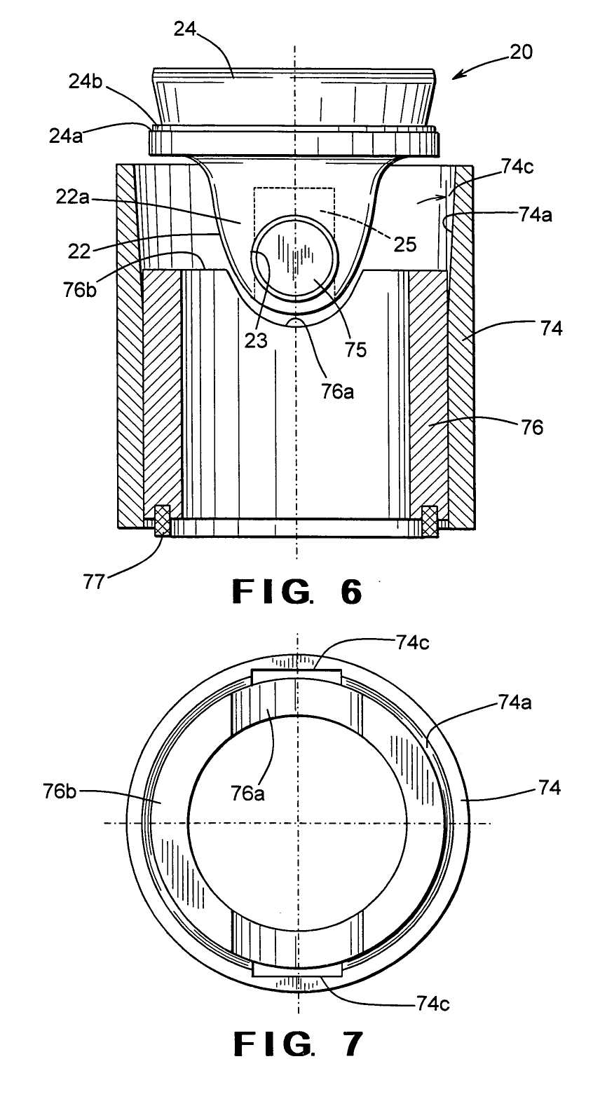

Before being inserted into the inductor 40, the tube yoke 20 and the yoke tooling (including the yoke bushing 74 and the counter die 76) are preferably preliminarily assembled outside of the magnetic pulse welding means 70, as shown more specifically in FIGS. 6 and 7. To facilitate assembly, the tube yoke 20 and the yoke bushing 74 are provided with mutually matched tapered surface areas. On the tube yoke 20, these tapered areas are provided as parts of outer surfaces of the yoke arms 22 near the aligned openings 23, such as shown at 22a in FIG. 6. Because the tube yoke 20 is usually made from forging a blank, the surface areas 22a are what is left over of the original forged surfaces after machining the openings 23 and the grooves or recesses 25. Afterwards, the surface areas 22a have a forging draft angle, which usually varies between about three degrees to about five degrees. If the tube yoke 20 is made by means of another method, the tapered surface areas can be preliminarily machined. At least one end of the yoke bushing 74 has an internal tapered surface 74a that defines an angle 74b (shown somewhat exaggerated in FIG. 6) that is about the same as or close to the angle of the surface areas 22a. Also, the yoke bushing 74 may have recesses 74c provided therein (see FIG. 5) to receive the ends of the pin 75. The counter die 76 is disposed inside the yoke bushing 74 and has arcuate recesses 76a formed therein that define a pair of opposed counter die arms 76b. The counter die 76 may also include the elastic damper 77. The purpose for counter die 76 and damper 77 will be explained below.

In the process of preliminary assembly, the pin 75 is initially inserted inside the openings 23 of the yoke 20. Then, the yoke 20 with the pin 75 are inserted inside the yoke bushing 74 in such a manner that the ends of the pin 75 slide along the recesses 74c. Finally, an axial load is applied to press the yoke 20 inside the yoke bushing 74 at a predetermined distance to provide a reliable connection of their matching tapered surfaces 22a and 74a by friction. Next, the counter die 76 can be disposed inside the yoke bushing 74 at the pre-assembly stage or later when the pre-assembled detail is loaded into the means 70.

The use of the heating means 60 and the magnetic pulse welding means 70 in the performance of the sequence of operations of magnetic pulse welding the driveshaft tube 10 with the tube yoke 20 will be now explained. This sequence includes the loading operations and the actual welding operations. Initially, as shown in FIG. 5, the driveshaft tube 10 is located inside the cooler 63 and the heating inductor 61 in such a manner that the end portion 11 is disposed inside the inductor 61 and the tube end surface 12 is aligned, at least approximately, to a side surface 61a of the inductor 61. The inserts 65 are actuated to move axially into the tapered bore of the cooler 63 to clamp the driveshaft tube 10, and a coolant (such as water) is circulated through the passageways 64 of the cooler 63. The yoke 20, the pin 75, the yoke bushing 74, and counter die 74 are pre-assembled as described above, then are inserted within the tooling bushing 72 and fixed therein, such as by threaded the union nut 73 onto the threaded end of the tooling bushing 72, for example. The correct axial and radial positions of the neck portion 24 of the yoke 20 relative to the inductor 40 are defined by the dimensions of the yoke bushing 74. In the process of tightening the union nut 73, the counter die 74 is actuated through damper ring 77 to move axially toward the end fitting 20 until the outer portions of the yoke arms 22 are received within the arcuate recess 76a formed therein. The damper ring 77 is preferably soft enough to avoid separating the yoke 20 and the bushing 74 in the process of tightening the union nut 73. As best shown in FIG. 6, the yoke arms 22 of the yoke 20 engage the opposed counter die arms 76b so as to be positively positioned relative thereto in the axial direction (i.e., from top to bottom when viewing FIG. 5).

Thereafter, the actual welding operations are performed. A high frequency alternating current is passed through the heating inductor 61 from the power supply 62, and the charging switch 56 is closed to transfer electrical energy from the source 55 to the capacitors 54 (see FIG. 2). The alternating current is applied for a sufficient length of time to heat the end portion 11 of the driveshaft tube 10 to a predetermined temperature that is controlled by a temperature gauge, for example, an infrared gauge (not shown). Next, the alternating current is switched off, the inserts 65 are actuated to move out of the cooler 63 to unclamp the driveshaft tube 10, and the driveshaft tube 10, with the help of a liner actuator (not shown) or other desired mechanism, is actuated to move through directed bushing 71 into pulse inductor 40 to dispose the end portion 11 around the annular step 24b of the tube yoke 20, preferably in abutment with the shoulder 24a so as to define the axial position of the end surface 12 of the driveshaft tube 10. When the driveshaft tube 10 has been properly positioned in this manner, the segmented clamp 46 is energized to maintain it in this position.

Before the moment of contact of the end surface 12 of the driveshaft tube 10 with the shoulder 24a, the capacitors 54 are preferably charged to the predetermined voltage. This allows the discharge switch 52 to be closed immediately (or with only a short delay) after the moment that the end surface 12 of the driveshaft tube 10 contacts the shoulder 24a. As a result, the inductor 40 is then energized to perform the magnetic pulse welding operation, as described above.

As previously discussed, the high velocity impact of the end portion 11 of the driveshaft tube 10 onto neck portion 24 of the yoke 20 during the magnetic pulse welding operation can, in some instances, cause the yoke arms 22 to be permanently deflected relative to one another and cause the enlargement of the dimensions of the opening 23. Reducing the energy of the magnetic pulse by preheating the end portion 11 of the driveshaft tube 10 reduces the amount of yoke distortion significantly. If the level of distortion is acceptable, simpler tooling can be used. However, if such permanent deflection and enlargement are unacceptable, further reducing or eliminating of such distortion will result when the tube yoke 20 is engaged and supported by the yoke bushing 74 and the counter die 76 as described above. During the magnetic pulse welding operation, the yoke bushing 74 prevents the yoke arms 22 from spreading outwardly apart from one another and thus causing the inward deformation of the neck portion 24. Also, the counter die 76 and the damper 77 absorb the energy of the shock wave that is propagated through the yoke 20 as a result of the impact in the process of the magnetic pulse welding, and that eliminates the configuration distortion of the openings 23 formed through yoke arms 22. The shock wave decreases the strength of friction engagement between tapered surface 22a of the yoke 20 and the matching tapered surface 74a of the yoke bushing 74, which facilitates the unloading of the driveshaft from magnetic pulse welding means 70 after finishing the magnetic pulse welding operation.

It will be appreciated that using the cooler 63 is not an essential part of the magnetic pulse welding process of this invention. It is useful when a heat affected tube area has to be very small, but the power of heating source 62 is relatively low to heat the tube end 11 fast enough. If the power of the heating system is sufficient to provide such heating at about four to six seconds, the cooler 63 could be removed altogether or, alternatively, be replaced with just simple directed bushing. Also, using the union nut 73 to retain the pre-assembled parts inside the tool bushing 72 is the simplest method of solving this task. Naturally, for high volume production, other well-known mechanized and automated technical means could be used. Also, the above-described pre-assembly operation could be performed with the help of tooling incorporated with the magnetic pulse welding means 70.

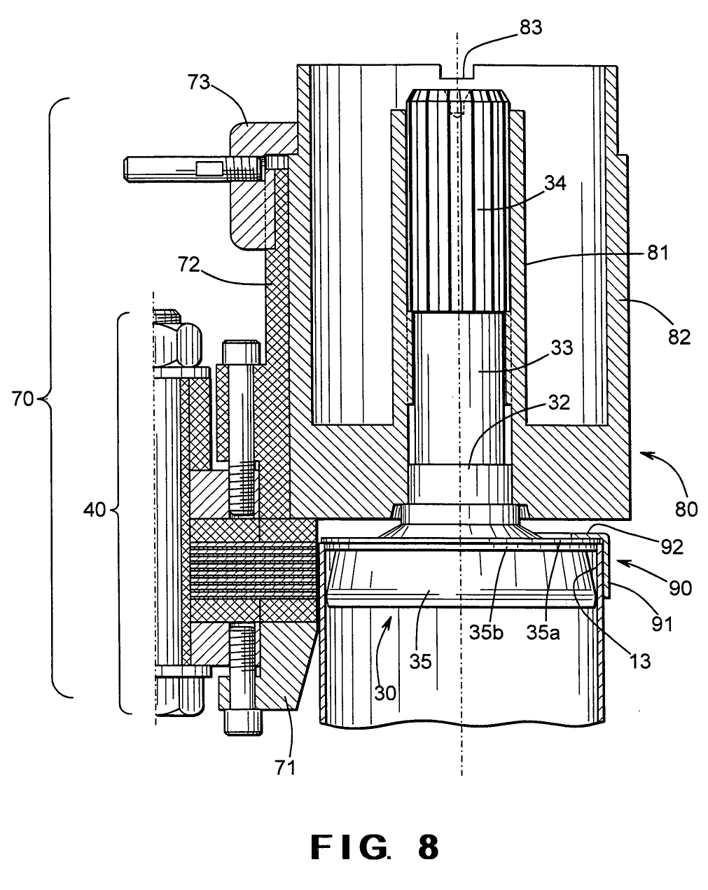

Referring now to FIG. 8, the preheating means 60 and the magnetic pulse welding means 70 are shown in connection with the magnetic pulse welding of the driveshaft tube 10 with the tube shaft 30. The actual welding operations are identical to those described in connection with the magnetic pulse welding of the driveshaft tube 10 with the tube yoke 20. In this instance, a tube shaft bushing 80 having an inner sleeve portion 81 and an outer sleeve portion 82 is provided. In the process of preliminary assembly, the tube shaft 30 is inserted inside the inner sleeve portion 81 of the tube shaft bushing 80 in such a way that bearing or boot seat portion 32 is precisely located inside the sleeve 81. Additionally, a blind spline of the splined end 34 can be aligned with a blind groove provided on the inside the inner sleeve portion 81. Next, the assembly of the tube shaft 30 and the tube shaft bushing 80 is inserted inside the tooling bushing 72. A conventional phasing operation can be performed if desired, which provides right angular positioning of the tube shaft 30 relative to the tube yoke 20 secured to the other end of the driveshaft tube 10. For facilitating the attachment and use of a conventional phasing device (not shown), the outer sleeve portion 82 of the bushing 80 has one or more recesses 83 provided therein. Finally, magnetic pulse welding cycles are performed as described above.

Welding driveshafts made of aluminum tube is one of the many objects for implementation of this invention. However, in some cases, this method could be very useful for welding steel tube driveshafts, especially if the tube is made from high strength steel and has a very thin wall-thickness. Because of the relatively low electrical conductivity of steel, magnetic pulse treatment of the parts made from this material is usually difficult without using a driving element (a sheet or a ring) made from material of high electric-conductivity, such as aluminum or copper. To provide magnetic pulse welding of steel tubes, the driving ring usually is preliminarily press-fit over the tube end before inserting the to-be-welded parts inside the pulse inductor. However, this convenient method of attaching the driving ring may not be able to be used in the present invention because melting temperature of the driving ring material is typically much lower than the temperature necessary to preheat the steel.

To address this limitation, the driving ring may be preliminarily located inside the pulse inductor. The internal diameter of the driving ring should be larger than the outer diameter of the to-be-welded tube end after preheating to permit this end to be inserted inside this ring. The best method of locating the driving ring is shown in FIG. 8, where a driving ring 90, such as can be made by stamping a sheet of material, is preliminarily press-fit over the annular shoulder 35a of the fitting neck 35, and is inserted into inductor 40 together with the neck 35. The shape of the driving ring 90 can be different, depending upon the end fitting configuration. To magnetic pulse weld the end portion 13 of the driveshaft tube 10 with the tube shaft 30, a driving ring 90 having cylindrical section 91 and flat section 92 is more appropriate because of the small axial dimension of the shoulder 35a of the neck 35. To weld the end portion 13 of the driveshaft tube 10 with yoke 20, the use of a driving ring 90 having just a cylindrical section 91 would be more appropriate.

The operations of preheating and direct magnetic pulse welding are the same as above described. Usually, after the magnetic pulse welding process is completed, the driving ring 90 is an undesirable element of the welding joint. It could be left after welding, if it is acceptable, or it may be cut off. However, in the context of the driveshaft tube magnetic pulse welding application, the driving ring 90 (which is typically very tightly crimped or even welded by the magnetic pulse welding process to the outer surface of the end portion of the driveshaft tube) could be used for attaching a balancing weight by means of contact (resistance), arc, or other appropriate welding method. Usually, such balancing weights are welded to the driveshaft tube in direct proximity to the yoke and tube shaft. These welding spots often are the weakest places of the driveshaft, from which fatigue cracks start. So, welding the balancing weights to the driving ring 90 provides an opportunity to solve an additional problem encountered in the manufacture of driveshaft assemblies. The balancing weights usually are made from steel, which has bad weldability with any aluminum alloy. Because copper and many copper alloys do not have such a problem, they are the best material for driving ring if the latter is planned to be used for attaching the balancing weight by welding.

Cleaning the to-be-welded metal surfaces to provide a good quality welding join is an important step of any magnetic pulse welding process. However, there have not been any commonly accepted criteria to evaluate surface purity and the method of cleaning in magnetic pulse welding technology. Most often, different methods of chemical cleaning are used that are inherently environmentally unfriendly and have other disadvantages. For this reason, a lot of attempts have been made to find better cleaning methods, but no one has been able to surpass chemical methods in terms of warranting the quality of the welding join. Investigations in the driveshaft applications have shown that machining the to-be-welded surfaces of metal (skimming) by dry cut or by cut lubricated with acetone or alcohol provides the best results in comparison with other mechanical methods, such as honing, sanding, sandblasting and dry-ice-blasting. However, in terms of fatigue life, the quality of magnetic pulse welding joins without preheating that have been chemically cleaned are better than those that have been welded after mechanical skimming.

It has been found that mechanically skimming the to-be-welded surfaces of aluminum 6061-T6 alloy by dry cut or cut with lubrication by acetone or alcohol both yield a quality of welding join by the magnetic pulse welding process described by the present invention which is comparable to chemical cleaning.

Several examples of the method of this invention will now be described.

### EXAMPLE 1

One end of the driveshaft tube 114 mm×2.5 mm made from aluminum 6061-T6 alloy was welded according with the present invention using the layout shown in FIG. 3a with an end yoke made from aluminum 6061-T6 alloy. The second end of this tube was welded according to the layout shown in FIG. 3b with the tube shaft made from heat treated steel 4140. Tooling for supporting the end fittings was partly incorporated with the pulse inductor as shown in FIGS. 5 and 8. The one-turn pulse inductor 40 and the pulse power supply 50 (see FIG. 2) were made in accordance with U.S. Pat. No. 4,129,846. The battery 54 had a capacitance of approximately 8.4×103 F, a maximal voltage of about 5 kV, and maximal energy of charging of about 105 kJ. The discharge circuit had a frequency about 10 kHz, and amplitude current was about 1.4 MA if the battery voltage of about 3.5 kV was used. The induction heating system 60 (see FIG. 3) had a maximal power of about 10 kW of supply 62 and a frequency of about 30 kHz with the water-cooled, one-turn inductor 61. The preheating temperature was measured by a Flucke 51II thermometer. Aluminum parts before welding were chemically cleaned by Arcal “Weld-O” (containing 5% hydrofluoric acid) and flushed in cold water, while the steel fittings were cleaned with acetone.

It was found that for an operator-controlled magnetic pulse welding process, the temperature of tube ends preheating to about 700° F. to about 900° F. is optimal for both aluminum-aluminum and aluminum-steel joints. It was also found that for an automatically controlled magnetic pulse welding process, the optimal temperature could be higher, such as about 1000° F. If the temperature was 750° F., the maximal voltage was about 2.6 kV, and the maximal energy of charging was about 28.4 kJ, and that was sufficient to get good quality welding joins for both aluminum-aluminum and aluminum-steel joints. Without preheating, using a maximal voltage of about 4.0 kV and a maximal energy of charging of about 67.2 kJ, this was insufficient to get any welding marks for either aluminum-aluminum and aluminum-steel joints. If, on the other hand, the temperature was greater than or equal to about 400° F., it was relatively easy to experimentally find a maximal voltage that was necessary to get good quality aluminum-aluminum joint. However, this is not as easy to do for the aluminum-steel joint because of the influence of the brittle aluminum-steel inter-metallic structures formed in the welding join. The general tendency is to raise the temperature higher to facilitate the finding of the maximal voltage necessary to provide good quality the aluminum-steel welding joint. The yoke ears deflection was acceptable without using bushing 74 and damper 76 (see FIG. 5); presence of a small, circularly uniform tube area with higher plasticity in the direct proximity to the fitting neck just slightly reduces maximal static torque of the driveshaft and is highly favorable for extending its fatigue life. Direct comparison under the same test conditions showed that magnetic pulse welding by the present invention extends the driveshaft fatigue life about 50% compared to using magnetic pulse welding without preheating and 2-3 times compared to ordinary arc welding.

### EXAMPLE 2

Both ends of the driveshaft tube 127 mm×2 mm made from aluminum 6061-T6 alloy were welded according with the present invention using the layout shown in FIGS. 3a and 3b with end yokes made from aluminum 6061-T6 alloy. The tooling and apparatus were similar to those described above. A good aluminum-aluminum welding joint was achieved using a temperature of about 750° F. and a maximal voltage of about 2.4 kV (maximal energy of charging of about 24.2 kJ). Ultrasonic measurements of the shape of the area of atomic joining surfaces of metal on many shafts did not show the presence of any non-uniformity that could be related with a non-uniform electromagnetic field in the slit area of the one turn heating inductor. So, using the present invention, it may not be necessary to rotate the tube in the process of preheating, which is a well-known method of eliminating circular non-uniformity of tube induction heating.

In accordance with the provisions of the patent statutes, the principle and mode of operation of this invention have been explained and illustrated in its preferred embodiment. It must be understood that this invention may be practiced otherwise than as specifically explained and illustrated without departing from its spirit or scope.

What is claimed is:

1. A method of performing magnetic pulse welding operation to secure first and second metallic components together comprising the steps of:
(a) providing first and second metallic components;
(b) increasing the temperature of a first portion of the first metallic component to soften same without substantially increasing the temperature of and softening a second portion of the first metallic component adjacent to the first portion;
(c) disposing the first portion of the first metallic component in an axially overlapping manner relative to a portion of the second metallic component with a space therebetween;
(d) providing an inductor relative to the axially overlapping portions of the first and second metallic components; and
(e) energizing the inductor to deform the first portion of the first metallic component into engagement with the portion of the second metallic component so as to secure the first and second metallic components together.

2. The method defined in claim 1 wherein said step (b) is performed by disposing the first portion of the first metallic component within a preheating inductor and energizing the preheating inductor to increase the temperature of the first portion of the first metallic component to soften same.

3. The method defined in claim 2 wherein said step (b) is further performed by disposing the second portion of the first metallic component within a cooling device while the preheating inductor is energized to prevent the temperature of the second portion of the first metallic component from being substantially increased.

4. The method defined in claim 3 wherein said step (b) is performed by providing the cooling device having inserts that engage the second portion of the first metallic component to prevent the temperature of the second portion of the first metallic component from being substantially increased.

5. The method defined in claim 1 wherein said step (a) is performed by providing the second metallic component with a tapered surface having a maximum diameter that is substantially equal to an inner diameter of the first portion of the first metallic component after said step (b) is performed.

6. The method defined in claim 1 wherein said step (b) includes the step of preheating the portion of the second metallic component.

7. The method defined in claim 1 wherein said step (c) is performed by applying an axial force against the first and second metallic components.

8. The method defined in claim 1 wherein said step (c) is performed by supporting the second metallic component in a tooling bushing and disposing the first portion of the first metallic component in an axially overlapping manner relative to the tooling bushing and the portion of the second metallic component.

9. The method defined in claim 1 wherein said step (a) is performed by providing a driveshaft tube and an end fitting.

10. A method for performing magnetic pulse welding operation to secure first and second metallic components together comprising the steps of:
(a) providing first and second metallic components;
(b) providing first and second inductors;
(c) orienting the first metallic component such that a first portion thereof is disposed within the first inductor and that a second portion thereof adjacent to the first portion is not disposed within the first inductor;
(d) energizing the first inductor to increase the temperature of the first portion of the first metallic component to soften same without substantially increasing the temperature of and softening the second portion of the first metallic component;
(e) disposing the first portion of the first metallic component in an axially overlapping manner relative to a portion of the second metallic component with a space therebetween and relative to the second inductor; and
(f) energizing the second inductor to deform the first portion of the first metallic component into engagement with the portion of the second metallic component so as to secure the first and second metallic components together.

11. The method defined in claim 10 wherein said step (b) is performed by disposing the first portion of the first metallic component within a preheating inductor and energizing the preheating inductor to increase the temperature of the first portion of the first metallic component to soften same.

12. The method defined in claim 11 wherein said step (b) is further performed by disposing the second portion of the first metallic component within a cooling device while the preheating inductor is energized to prevent the temperature of the second portion of the first metallic component from being substantially increased.

13. The method defined in claim 12 wherein said step (b) is performed by providing the cooling device having inserts that engage the second portion of the first metallic component to prevent the temperature of the second portion of the first metallic component from being substantially increased.

14. The method defined in claim 10 wherein said step (a) is performed by providing the second metallic component with a tapered surface having a maximum diameter that is substantially equal to an inner diameter of the first portion of the first metallic component after said step (b) is performed.

15. The method defined in claim 10 wherein said step (b) includes the step of preheating the portion of the second metallic component.

16. The method defined in claim 10 wherein said step (c) is performed by applying an axial force against the first and second metallic components.

17. The method defined in claim 10 wherein said step (c) is performed by supporting the second metallic component in a tooling bushing and disposing the first portion of the first metallic component in an axially overlapping manner relative to the tooling bushing and the portion of the second metallic component.

18. The method defined in claim 10 wherein said step (a) is performed by providing a driveshaft tube and an end fitting.

19. A method for performing magnetic pulse welding operation to secure first and second metallic components together comprising the steps of:
(a) providing a pulse inductor and a preheating inductor;
(b) orienting the first metallic component such that a portion thereof is disposed within the preheating inductor;
(c) energizing the preheating inductor to increase the temperature of the portion of the first metallic component so as to substantially reduce heating of an adjacent portion of the first metallic component;
(d) moving the first metallic component such that the heated portion thereof is disposed inside the pulse inductor in an axially overlapping manner relative to a portion of the second metallic component with a space therebetween; and
(e) energizing the pulse inductor to perform a magnetic pulse welding operation to secure the portion of the first metallic component to the portion of the second metallic component.
